(19) United States
(12) Patent Application Publication
(10) Pub. No.: US 2012/0070620 A1
(43) Pub. Date: Mar. 22, 2012

(54) SELF-ADHESIVE FRAME

(75) Inventors: Ahmet Comert, Herve (BE); Ronny R. Senden, Maasmechelen (BE); Dino Manfredi, Lummen (BE); Georges Moineau, Battice (BE)

(73) Assignee: SAINT-GOBAIN PERFORMANCE PLASTICS CORPORATION, Aurora, OH (US)

(21) Appl. No.: 13/237,739

(22) Filed: Sep. 20, 2011

Related U.S. Application Data
(60) Provisional application No. 61/384,643, filed on Sep. 20, 2010.
(60) Provisional application No. 61/387,235, filed on Sep. 28, 2010.

(51) Int. Cl. B32B 3/30; B65B 17/00; B32B 38/00; B32B 7/12; B32B 37/12; B32B 37/14

(52) U.S. Cl. 428/156; 156/293; 53/428

(57) ABSTRACT

A shipping assembly includes a packaging sufficient for transport, and a plurality of frame assemblies within the packaging. Each frame assembly includes a frame having a groove configured to receive a flat panel, and an adhesive disposed within the groove. The groove has first and second side surfaces and a base surface therebetween. In an embodiment, the adhesive is an adhesive tape including a compressible core and a first adhesive surface. In another embodiment, the adhesive is a liquid adhesive having a viscosity of at least about 25 Pa·s at a temperature of 40° C. In yet another embodiment, the adhesive is a semi-liquid adhesive having a viscosity of not greater than about 200 Pa·s at a temperature of 150° C.

This application claims priority to and the benefit of U.S. Prov. Pat. App. No. 61/384,643, filed Sep. 20, 2010, and U.S. Prov. Pat. App. No. 61/387,235, filed Sep. 28, 2010, both of which are incorporated herein by reference in their entirety.

### FIELD OF THE DISCLOSURE

The present disclosure generally relates to frames for panels, and more particularly relates to self-adhesive frames.

### BACKGROUND

As economies around the world grow, demand for energy continues to increase. As a result, the price of traditional fossil fuel energy sources continues to increase as well. However, increased usage of fossil fuel sources has disadvantages such as detrimental environmental impact and theorized limits in supply.

Governments and energy industries are looking toward alternative energy sources for fulfilling future supply requirements. However, alternate energy sources have a higher per kilowatt-hour cost than traditional fossil fuel sources. One such alternate energy source is solar power. In typical solar power systems, photovoltaic devices absorb sunlight to produce electrical energy. Typical photovoltaic devices include polymer/glass laminates containing an active photovoltaic cell, the laminate structure being sealed and held together in a framed structure. Such laminate structures can be referred to as a flat panel.

Typical devices are sealed and assembled by placing the panel inside the frame. Generally, the panel and frame are sealed by the use of a liquid sealant or a double-sided tape. However, liquid sealants and tape can be messy, wasteful, and labor intensive. For example, excess liquid sealants need to be removed from the module and the device must be stored carefully to allow proper curing of the sealant. Double-sided tape may be particularly difficult to apply, especially on the corners of the photovoltaic device. In a current technique, a tape is applied to the panel periphery, generally along opposite major surfaces and the peripheral edge. The thus deployed panel carrying tape is forced into a frame. However, assembly following this approach is tedious and time consuming.

U.S. Publication 2010/0147443 discloses an adhesive tape including a foaming agent. The adhesive tape can be applied to the frame in an unexpanded form and the photovoltaic panel can be inserted into the groove. The width of the groove can be greater than the thickness of the photovoltaic panel plus the thickness of the two adhesive tapes, leaving a gap between adhesive tape and the panel. The assembly can be heated to activate the foaming agent within the adhesive tape to expand the adhesive tape to fill the gap. However, when using a photovoltaic panel including a plurality of thermoplastic polymers, heating of the assembly may be problematic. Potential issues include deformation of thermoplastic polymers, thereby damaging the photovoltaic panel, as well as fabrication complexity, cost, etc. As such, improved photovoltaic devices, frames, packaged frames, and assembly techniques would be desirable.

### SUMMARY

In an embodiment, a frame assembly for receiving a flat panel having a thickness (Tₚ) includes a frame including a groove and an adhesive disposed within the groove. The groove has first and second side surfaces and a base surface therebetween and is configured to receive an edge of the flat panel. The adhesive is selected from the group consisting of (ii) an adhesive tape including a first adhesive surface and a compressible core, (ii) a liquid adhesive having a viscosity of at least about 25 Pa·s at a temperature of 40° C., and (iii) a semi-liquid adhesive having a viscosity of not greater than about 200 Pa·s at a temperature of 150° C. The adhesive is in contact with one of the first side surface, the second side surface, the base surface, and any combination thereof. The frame is free of a flat panel such that the adhesive is in contact with the frame but not a flat panel.

In another embodiment, a shipping assembly includes a packaging sufficient for transport and a plurality of frame assemblies within the packaging. Each frame assembly includes a frame having a groove and an adhesive disposed within the groove. The groove is configured to receive a panel and has first and second side surfaces and a base surface therebetween. The adhesive selected from the group consisting of (i) an adhesive tape including a first adhesive surface and a compressible core, (ii) a liquid adhesive having a viscosity of at least about 25 Pa·s at a temperature of 40° C., and (iii) a semi-liquid adhesive having a viscosity of not greater than about 200 Pa·s at a temperature of 150° C.

In a further embodiment, a method of preparing a frame assembly for shipping includes providing a plurality of frames. Each frame has a groove configured to receive a flat panel. The groove has first and second side surfaces and a base surface therebetween. The method further includes applying an adhesive within the groove of each frame to form a plurality of frame assemblies, and securing the frame assemblies within a shipping package suitable for transport. The adhesive is selected from the group consisting of (i) an adhesive tape including a first adhesive surface and a compressible core, (ii) a liquid adhesive having a viscosity of at least about 25 Pa·s at a temperature of 40° C., and (iii) a semi-liquid adhesive having a viscosity of not greater than about 200 Pa·s at a temperature of 150° C.

In yet another embodiment, a method of assembling a panel includes receiving a shipping package suitable for transport. The shipping package includes a plurality of frame assemblies. Each frame assembly includes a frame having a groove configured to receive a panel and an adhesive disposed within the groove. The groove has first and second side surfaces and a base surface therebetween. The adhesive is selected from the group consisting of (i) an adhesive tape including a first adhesive surface and a compressible core, (ii) a liquid adhesive having a viscosity of at least about 25 Pa·s at a temperature of 40° C., and (iii) a semi-liquid adhesive having a viscosity of not greater than about 200 Pa·s at a temperature of 150° C. The method further includes removing a first frame assembly from the shipping package, and inserting a panel into the groove of the first frame assembly.

In still another embodiment, a method of assembling a panel includes receiving a frame assembly. The frame assembly includes a frame having a groove, and an adhesive disposed within the groove. The groove has first and second side surfaces and a base surface therebetween and is configured to receive an edge of a panel. The adhesive is selected from the group consisting of (i) an adhesive tape including a first adhesive surface and a compressible core, (ii) a liquid adhesive having a viscosity of at least about 25 Pa·s at a temperature of 40° C., and (iii) a semi-liquid adhesive having a viscosity of not greater than about 200 Pa·s at a temperature of 150° C. The adhesive is in contact with one of the first side surface, the second side surface, the base surface, and any combination thereof. The method further includes inserting a panel into the groove.

### BRIEF DESCRIPTION OF THE DRAWINGS

The present disclosure may be better understood, and its numerous features and advantages made apparent to those skilled in the art by referencing the accompanying drawings.

FIGS. 1 and 2 are diagrams illustrating exemplary frame assemblies according to aspects of the present disclosure.

FIGS. 3 and 4 are diagrams illustrating exemplary shipping assemblies according to aspects of the present disclosure.

FIG. 5 is a diagram illustrating an exemplary panel assembly according to an aspect of the present disclosure;

FIGS. 6-9 are photographic images of frames and panels; and

FIG. 10 is a sectional side view of another embodiment of a frame assembly.

The use of the same reference symbols in different drawings indicates similar or identical items.

### DETAILED DESCRIPTION

In an embodiment, a frame assembly for receiving a flat panel can include a frame having a groove, and an adhesive disposed within the groove. The groove can be configured to receive an edge of the flat panel. The adhesive can be a liquid or semi-liquid adhesive or an adhesive tape, such as a single-sided or double-sided tape.

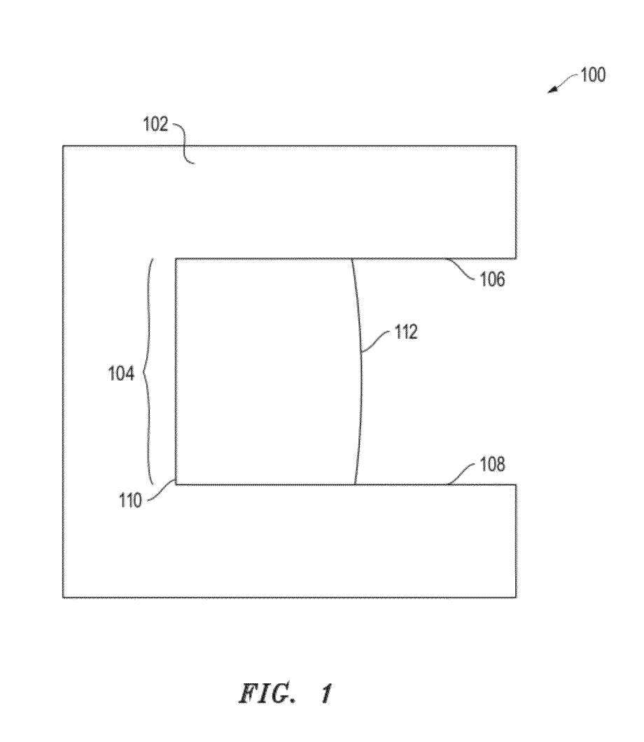

FIG. 1 illustrates a cross section of an exemplary frame assembly 100. The frame assembly 100 can include a frame 102 and a groove 104. The frame 102 may be made of any reasonable material that retains its rigidity under external or internal stress. In an embodiment, the frame 102 may be metal, polymer, or composite material. In one embodiment, the composition of the frame is aluminum-based, oftentimes an aluminum alloy formed of at least 60 wt %, at least 70 wt %, 80 wt %, or at least 90 wt % aluminum. An aluminum based alloy may be alloyed with common used elements such as Cu, Mn, Si, Mg, and Zn. The frame 102 may be made as one piece, or as several parts that are butted together during fitting. The one piece frame can have a construction as taught in US Publication 2010/0000605. The cross section of the frame 102 may be square, rectangular, etc.

The groove 104 may be of any shape for its cross-section. Typically, the groove 104 is a channel. The groove 104 can have side surfaces 106 and 108 and a base surface 110 extending between the side surfaces 106 and 108. In an embodiment, the groove 104 has a rectangular cross-section. The side surfaces 106 and 108 can be substantially parallel to each other and the base surface 110 can be substantially perpendicular to the side surfaces 106 and 108. Alternatively, the groove can have a trapezoidal cross-section.

The groove 104 can have a depth and width sufficient to fit an edge of a flat panel. The groove can have a depth of 2 mm to 25 mm, such as from 5 mm to 20 mm, even from 8 mm to 15 mm. Additionally, the width can be from 2 mm to 20 mm, such as from 4 mm to 15 mm.

Advantageously, the groove 104 can be at least partially filled with an adhesive 112. For example, the groove can be filled from 20% to 80% with the adhesive 112, such as from 30% to 70% filled. The adhesive can include an adhesive polymer. The adhesive polymer can be a reactive polymer, such as a moisture cured or a thermally cured polymer, or a non-reactive polymer, such as a pressure sensitive adhesive or a thermoplastic adhesive. In an embodiment, the adhesive can be a liquid adhesive or a semi-liquid adhesive. A liquid adhesive can be a viscous liquid at an ambient temperature, such as about 40° C., and can remain a viscous liquid until cured. A semi-liquid adhesive can be a liquid at an elevated temperature, such as at least about 100° C., and can be substantially solid at an ambient temperature.

Compositions suitable as the adhesive polymer include, for example, thermoplastic polymers, elastomers, natural and synthetic rubber, silicones, thermoset polymers, such as cross-linkable thermoset polymers, hot melt adhesives, butyls, and combinations thereof. Exemplary polymers include polyalkylenes (e.g., polyethylene, polypropylene and polybutylene), poly(alpha)olefins including, e.g., homo-, co- and terpolymers of aliphatic mono-1-olefins (alpha olefins) (e.g., poly(alpha)olefins containing from 2 to 10 carbon atoms), homogeneous linear or substantially linear interpolymers of ethylene having at least one C₃ to C₂₀ alphaolefin, polyisobutylenes, poly(alkylene oxides), poly(phenylenediamine terephthalamide), polyesters (e.g., polyethylene terephthalate), polyacrylates, polymethacrylates, polyacrylamides, polyacrylonitriles, copolymers of acrylonitrile and monomers including, e.g., acrylonitrile butadiene rubber (NBR), butadiene, styrene, polymethyl pentene, and polyphenylene sulfide (e.g., styrene-acrylonitrile, acrylonitrile-butadiene-styrene, acrylonitrile-styrene-butadiene rubbers), polysulfides, polyimides, polyamides, copolymers of vinyl alcohol and ethylenically unsaturated monomers, polyvinyl acetate (e.g., ethylene vinyl acetate (EVA)), polyvinyl alcohol, vinyl chloride homopolymers and copolymers (e.g., polyvinyl chloride), polysiloxanes, polyurethanes, polystyrene, and combinations thereof, and homopolymers, copolymers and terpolymers thereof, and mixtures thereof. In an embodiment, the polymer is free from isocyanates. In an embodiment, the adhesive polymer is a polyurethane. In an alternative embodiment, the adhesive polymer is a poly-alpha-olefin. In another embodiment, the adhesive polymer is a blend of ethylene propylene diene monomer (EPDM) rubber and polypropylene; for example, the polymers that are obtainable under the trade name SANTOPRENE(R).

In a particular embodiment, a semi-liquid adhesive can include any suitable polymer that has an initial melt viscosity of about 0.010 Pa·s to about 200 Pa·s at 150° C. In an embodiment, the polymer has an initial melt viscosity of about 0.5 Pa·s to about 50 Pa·s at 150° C.

In an embodiment, the polymer is a poly-alpha-olefin. Typically, the poly-alpha-olefin includes homo-, co-, and terpolymers of aliphatic mono-1-olefins (alpha olefins) (e.g., poly(alpha)olefins containing from 2 to 10 carbon atoms). In an embodiment, the poly-alpha-olefin may include an alpha-olefin having 4 to 10 carbon atoms in addition to, or instead of 1-butene such as, for example, 3-methyl-1-butene, 1-pentene, 1-hexene, 3,3-dimethyl-1-butene, 4-methyl-1-pentene, 1-heptene, 1-octene or 1-decene. In an exemplary embodiment, the poly-alpha-olefin contains about 0.1% to about 100% by weight of alpha-olefins containing 4 to 10 carbon atoms. In an embodiment, propene may be present at an amount of about 0.1% to about 98% by weight, such as about 30% to about 80% by weight, based on the total weight of the poly-alpha-olefin. In an embodiment, ethene may be present at an amount of about 1% to about 95% by weight, such as about 0% to about 10% by weight, or even about 3% to about 8% by weight, based on the total weight of the poly-alpha-olefin. In an embodiment, the ratio of different monomers may be adjusted depending on the properties desired, such as hardness, melt viscosity, and crystallinity. Suitable poly-alpha-olefins include terpolymers such as propene/1-butene/ethene terpolymers and propene/1-butene copolymers; for example, the polymers that are obtainable under the trade name VESTOPLAST(R).

In an embodiment, the poly-alpha-olefin is grafted to increase the adhesion of the poly-alpha-olefin to a substrate. Any known adhesion promoting grafting species may be used. Any amount of a grafting species may be used that substantially improve the adhesion of the poly-alpha-olefin to the substrate. In an embodiment, the poly-alpha-olefin may be grafted with an anhydride, such as maleic anhydride (e.g. VESTOPLAST 308), or a silane.

In an embodiment, an unsaturated silane is grafted on the poly-alpha-olefin. In a particular embodiment, the silane has at least one olefinic double bond and one to three alkoxy groups bonded directly to the silicon. In an embodiment, the silane to be grafted has three alkoxy groups bonded directly to the silicon. Vinyltrimethoxysilane (VTMO), vinyltriethoxysilane, vinyl-tris(2-methoxyethoxy)silane, 3-methacryloyloxypropyltrimethoxysilane (MEMO; H2C═C(CH3)COO(CH2)3 - - - Si(OCH)3), 3-methacryloyloxypropyltriethoxysilane, vinyldimethylmethoxysilane or vinylmethyldibutoxysilane may be mentioned by way of example. In an embodiment, silanes include those in which the double bound is not directly linked to the silane, such as allyltrimethoxy silane, allyltriethoxy silane, and the like. In the grafting, the silane is typically used in amounts of up to about 20% by weight, such as about 0.1% to about 10% by weight, such as about 0.5% to about 5% by weight, based on the poly-alpha-olefin. The silane on the poly-alpha-olefin improves the adhesion of the polymer without the need for any primer.

The unsaturated silane is typically grafted onto the polyolefin by methods known to those of ordinary skill in the art, for example in solution or in the melt, with the addition of a free radical donor being used in sufficient amount. In an example, the silane group is hydrolyzed forming silanol groups. The polymer can subsequently be cross-linked, e.g. by silanol condensation or by reaction with hydroxy- functional polymers. Silanol condensation, reactions can be catalyzed by suitable silanol condensation catalysts such as organometallics, organic bases, acidic minerals and fatty acids. Exemplary organometallic include dibutyl tin dilaurate or tetrabutyl titanate. The catalyst may optionally be used in an amount of about 0.01% to about 0.2%, for example, from about 0.01% to about 0.5% by weight of the polymer.

In general, the poly-alpha-olefin is largely amorphous; that is, it has a degree of crystallinity of not more than 45%, as determined by X-ray diffraction. In an embodiment, the poly-alpha-olefin has a degree of crystallinity of not more than 35%. The crystalline fraction of the substantially amorphous poly-alpha-olefin can be estimated, for example, by determining the enthalpy of fusion by means of the DSC method. Typically, a weighed sample is first heated from about −100° C. to about +210° C. at a heating rate of about 10° C./min and then cooled again to about −100° C. at a rate of about 10° C./min. After the thermal history of the sample has been eliminated in this manner, heating is again effected at a rate of about 10° C./min to about 210° C., and the enthalpy of fusion of the sample is determined by integrating the melt peak which is attributable to the crystallite melting point Tm. Preferably, the enthalpy of fusion of the substantially amorphous polyolefin is not more than about 100 Joules/gram (J/g), more preferably not more than about 60 J/g, and particularly preferably not more than about 30 J/g.

The grafted substantially amorphous polyolefin typically has an initial melt viscosity in the range from about 1 to about 30 Pa·s, such as about 2 to about 20 Pa·s, and about 2 to about 15 Pa·s.

In another embodiment, the adhesive can be a one component (1K) polyurethane. The one component polyurethane precursor can be the reaction product of a polyol and an excess amount of isocyanate, resulting in a polyurethane precursor terminated with isocyanate groups. In the presence of water, a portion of the isocyanate groups are converted into amine groups, which will react with the remaining isocyanate groups resulting in a chemically crosslinked polyurethane network.

In an example, the polyol may be a polyether polyol, a polyester polyol, modified or grafted derivatives thereof, or any combination thereof. A suitable polyether polyol can be produced by polyinsertion via double metal cyanide catalysis of alkylene oxides, by anionic polymerization of alkylene oxides in the presence of alkali hydroxides or alkali alcoholates as catalysts and with the addition of at least one initiator molecule containing 2 to 6, preferably 2 to 4, reactive hydrogen atoms in bonded form, or by cationic polymerization of alkylene oxides in the presence of Lewis acids, such as antimony pentachloride or boron fluoride etherate. A suitable alkylene oxide may contain 2 to 4 carbon atoms in the alkylene radical. An example includes tetrahydrofuran, 1,2-propylene oxide, 1,2- or 2,3-butylene oxide; ethylene oxide, 1,2-propylene oxide, or any combination thereof. The alkylene oxides can be used individually, in succession, or as a mixture. In particular, mixtures of 1,2-propylene oxide and ethylene oxide may be used, whereby the ethylene oxide is used in quantities of 10% to 50% as an ethylene oxide terminal block so that the resulting polyols display over 70% primary OH terminal groups. An example of an initiator molecule includes water or dihydric or trihydric alcohols, such as ethylene glycol, 1,2-propanediol and 1,3-propanediol, diethylene glycol, dipropylene glycol, ethane-1,4-diol, glycerol, trimethylol propane, or any combination thereof.

Suitable polyether polyols, such as polyoxypropylene polyoxyethylene polyols, have average functionalities of 1.5 to 4, such as 2 to 3, and number-average molecular weights of 800 g/mol to 25,000 g/mol, such as 800 g/mol to 14,000 g/mol, particularly 2,000 g/mol to 9,000 g/mol.

In another example, the polyol may include a polyester polyol. In an exemplary embodiment, a polyester polyol is derived from dibasic acids such as adipic, glutaric, fumaric, succinic or maleic acid, or anhydrides and di-functional alcohols, such as ethylene glycol, diethylene glycol, propylene glycol, di or tripropylene glycol, 1-4 butane diol, 1-6 hexane diol, or any combination. For example, the polyester polyol may be formed by the condensation reaction of the glycol and the acid with the continuous removal of the water by-product. A small amount of high functional alcohol, such as glycerin, trimethanol propane, pentaerythritol, sucrose or sorbitol or polysaccarides may be used to increase branching of the polyester polyol. The esters of simple alcohol and the acid may be used via an ester interchange reaction where the simple alcohols are removed continuously like the water and replaced by one or more of the glycols above. Additionally, polyester polyols may be produced from aromatic acids, such as terephthalic acid, phthalic acid, 1,3,5-benzoic acid, their anhydrides, such as phthalic anhydride. In a particular example, the polyol may include an alkyl diol alkyl ester. For example, the alkyl diol alkyl ester may include trimethyl pentanediol isobutyrate, such as 2,2,4-trimethyl-1,3-pentanediol isobutyrate.

In a particular embodiment, the polyol may be a multifunctional polyol having at least two primary hydroxyl groups. For example, the polyol may have at least three primary hydroxyl groups. In a particular example, the polyol is a polyether polyol having an OH number in the range of 5 mg KOH/g to 70 mg KOH/g, such as a range of 10 mg KOH/g to 70 mg KOH/g, a range of 10 mg KOH/g to 50 mg KOH/g, or even 15 mg KOH/g to 40 mg KOH/g. In a further example, the polyether polyol may be grafted. For example, the polyol may be a polyether polyol grafted with styrene-acrylonitrile. In a further example, the polyol may include a blend of multifunctional, such as trifunctional polyether polyols, and polyols that are grafted, such as a polyether polyol having a grafted styrene-acrylonitrile moiety. In particular, the polyol is a polyether polyol, available under the trade name Lupranol® available from Elastogran by BASF Group.

The isocyanate may be derived from a variety of diisocyanates. An exemplary diisocyanate monomer may include toluene diisocyanate, m-phenylene diisocyanate, p-phenylene diisocyanate, xylene diisocyanate, 4,4′-diphenylmethane diisocyanate, hexamethylene diisocyanate, isophorone diisocyanate, polymethylene polyphenyl diisocyanate, 3,3′-dimethyl-4,4′-biphenylene diisocyanate, 3,3′-dimethyl-4,4′-diphenylmethane diisocyanate, 3,3′-dichloro-4,4′-biphenylene diisocyanate, or 1,5-naphthalene diisocyanate; their modified products, for instance, carbodiimide-modified products; or the like, or any combination thereof. Such diisocyanate monomers may be used alone or in admixture of at least two kinds. In a particular example, the isocyanate component may include methylene diphenyl diisocyanate (MDI), toluene diisocyanate (TDI), hexamethylene diisocyanate (HDI), isophorone diisocyanate (IPDI), or any combination thereof. In an example, the isocyanate may include methylene diphenyl diisocyanate (MDI) or toluene diisocyanate (TDI). In particular, the isocyanate includes methylene diphenyl diisocyanate (MDI) or derivatives thereof.

The diisocyanate may have an average functionality in a range of about 2.0 to 2.9, such as a functionality of between 2.0 and 2.7. Further, the diisocyanate may have an NCO content in the range of 5% to 35%, such as the range of 10% to 30%.

In a particular embodiment, the isocyanate component may be a modified methylene diphenyl diisocyanate (MDI). In a further example, a diisocyanate may include a mixture of diisocyanates, such as a mixture of modified methylene diphenyl diisocyanates. An exemplary diisocyanate is available under the trade name Lupranate®, available from Elastogran by the BASF Group.

In addition, the 1K polyurethane precursor may include a catalyst. The catalyst may include an organometallic catalyst, an amine catalyst, or a combination thereof. An organometallic catalyst, for example, may include dibutyltin dilaurate, a lithium carboxylate, tetrabutyl titanate, a bismuth carboxylate, or any combination thereof.

The amine catalyst may include a tertiary amine, such as tributylamine, N-methyl morpholine, N-ethyl morpholine, N,N,N′,N′-tetramethyl ethylene diamine, pentamethyl diethylene triamine and higher homologues, 1,4-diazabicyclo-[2,2,2]-octane, N-methyl-N′-dimethylaminoethyl piperazine, bis(dimethylaminoalkyl)piperazine, N,N-dimethyl benzylamine, N,N-dimethyl cyclohexylamine, N,N-diethyl benzylamine, bis(N,N-diethylaminoethyl)adipate, N,N,N′,N′-tetramethyl-1,3-butane diamine, N,N-dimethyl-β-phenyl ethylamine, bis(dimethylaminopropyl)urea, bis(dimethylaminopropyl)amine, 1,2-dimethyl imidazole, 2-methyl imidazole, monocyclic and bicyclic amidine, bis(dialkylamino)alkyl ether, such as e.g., bis(dimethylaminoethyl)ethers, tertiary amines having amide groups (such as formamide groups), or any combination thereof. Another example of a catalyst component includes Mannich bases including secondary amines, such as dimethylamine, or aldehyde, such as formaldehyde, or ketone such as acetone, methyl ethyl ketone or cyclohexanone or phenol, such as phenol, nonyl phenol or bisphenol. A catalyst in the form of a tertiary amine having hydrogen atoms that are active with respect to isocyanate groups may include triethanolamine, triisopropanolamine, N-methyldiethanolamine, N-ethyl diethanolamine, N,N-dimethyl ethanolamine, reaction products thereof with alkylene oxides such as propylene oxide or ethylene oxide, or secondary-tertiary amines, or any combination thereof. Silamines with carbon-silicon bonds can also be used as catalysts, for example, 2,2,4-trimethyl-2-silamorpholine, 1,3-diethyl aminomethyl tetramethyl disiloxane, or any combination thereof.

In a further example, the amine catalyst is selected from a pentamethyl diethylene triamine, dimethylaminopropylamine, N,N′dimethylpiperazine and dimorpholinoethylether, N,N′dimethyl aminoethyl N-methyl piperazine, JEFFCAT®DM-70 (a mixture of N,N′dimethylpiperazine and dimorpholinoethylether), imadozoles, triazines, or any combination thereof.

In a particular embodiment, the catalyst is particularly useful for activating blowing reactions, such as a reaction of isocyanate with water. In an example, the catalyst includes dimorpholinodiethyl ether (DMDEE). In a particular example, the catalyst includes a stabilized version of DMDEE.

An example composition includes the polyol in an amount in the range of 50 wt % to 80 wt %, such as a range of 55 wt % to 75 wt %, or even a range of 60 wt % to 70 wt %. The diisocyanate may be included in an amount in a range of 20 wt % to 35 wt %, such as a range of 22 wt % to 32 wt %, or even a range of 25 wt % to 30 wt %. The catalyst, and in particular a humidifier curing catalyst, may be included in an amount of 0.2 wt % to 2.0 wt %, such as a range of 0.6 wt % to 1.8 wt %, a range of 0.8 wt % to 1.8 wt %, or even a range of 1.0 wt % to 1.5 wt %.

The adhesive polymer may further include additives to impart particular properties on the adhesive polymer. For instance, pigments, fillers, catalysts, plasticizers, biocides, anti-yellowing agents, stabilizers, flame retardants, antioxidants, surfactants, tackifiers, adhesion promoting additives, and the like may be added. Exemplary pigments include organic and inorganic pigments. Suitable fillers include, for instance, silica, precipitated silica, talc, calcium carbonates, aluminosilicates, clay, zeolites, ceramics, mica, aluminum or magnesium oxide, quartz, diatomaceous earth, thermal silica, also called pyrogenic silica, and nonpyrogenic silica. The fillers may also be silicates such as talc, mica, kaolin, glass microspheres, or other mineral powders such as calcium carbonate, mineral fibers, or any combination thereof. Exemplary plasticizers include paraffinic oils, naphthenic oils, low molecular weight poly-1-butene, low molecular weight polyisobutene, and combinations thereof. In a particular embodiment, the foamed polymer includes adhesion promoting additives such as functional silanes or other adhesion promoters. Exemplary silanes include 3-aminopropyltrimethoxy silane, 3-(trimethoxysilyl)propyl methacrylate, 3-glycidoxypropyltrimethoxy silane, and n-ocryltrimethoxy silane. The adhesion promoter may optionally be used in an amount of about 0.01% to about 5.0%, for example from about 0.01% to about 2.0% by weight of polymer.

In another particular embodiment, the adhesive can be a liquid or semi liquid polymer adhesive. In a particular example, the liquid adhesive can a viscosity of at least about 25 Pa·s at a temperature of 40° C. The semi-liquid adhesive can have a viscosity of not greater than about 200 Pa·s at a temperature of 150° C.

In a particular embodiment, the frame assembly can include an optional liner. The liner can cover an exposed surface of the adhesive. For example, the liner can be removably adhered to the exposed surface. Alternatively, the liner can be configured to cover the entire groove, such as by extending across opening. The liner can be configured to substantially prevent dust or water vapor from contacting the exposed surface of the adhesive.

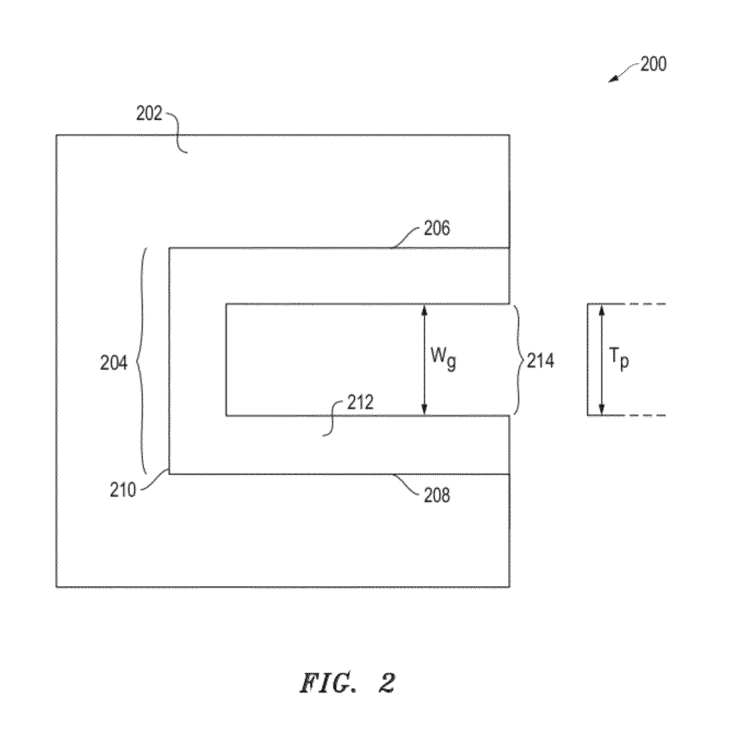

FIG. 2 illustrates a cross section of another exemplary frame assembly 200. The frame assembly 200 can include a frame 202 and a groove 204. The frame 202 and groove 204 may be substantially similar to frame 102 and groove 104 respectively. The groove 204 can have side surfaces 206 and 208 and a base surface 210 extending between the side surfaces 206 and 208.

The groove 204 can have a depth and width sufficient to fit an edge of a flat panel the groove can have a depth of 2 mm to 20 mm, such as from 5 mm to 20 mm. The width can be large enough to exceed the thickness of the flat panel and can be not greater than the thickness of the flat panel plus twice the thickness of the adhesive, so that when inserted into the groove 202, there are no gaps between the flat panel and the adhesive or between the adhesive and the side surfaces of the groove. Additionally, the width can be from 2 mm to 20 mm, such as from 4 mm to 8 mm.

In an embodiment, the side surfaces 206 and 208 can have an adhesive. Additionally, there can be a gap 214 remaining after the addition of the adhesive. In a particular embodiment, the gap 214 can have a width (W_{g}) less that the thickness of the panel (Tₚ) to be inserted. For example, the gap width can be less than 95% Tp, such as less than 90% Tp, such as less than 85% Tp, even less than 80% Tp. In further examples, the gap width can be less than 75% Tp, such as less than 70% Tp, such as less than 65% Tp, such as less than 60% Tp, such as less than 55% Tp, even less than 50% Tp.

The adhesive can be in the form of an adhesive tape and can be applied to at least one of the surfaces 206, 208, and 210 of the groove 204. The adhesive tape can include a compressible core and an adhesive polymer on a surface of the compressible core to form an adhesive surface. The compressible core can include a polymer foam substrate. Additionally, the compressible core can have a compressibility of from about 20% to about 50%, such as from about 25% to about 45%, even from about 30% to about 40%.

The adhesive tape can be a single-sided tape with an adhesive surface adjacent to one of the side surfaces, base surface, or side and base surfaces. Alternatively, the adhesive tape can be a double-sided tape with one adhesive surface adjacent to at least one of the side and/or the base surfaces and a second adhesive surface directed away from the surface of the groove and configured to adhere to the flat panel when inserted into the groove. The adhesive tape can include a polymer such as polyethylene, a polyurethane, a polyacrylate, a polymethacrylate, or any combination thereof. The adhesive tape can be folded and arranged to contact each of the surfaces of the groove. Alternatively, there can be a plurality of adhesive tapes, each adhered to one of the surfaces of the groove.

In a particular example, double sided adhesive tapes can be adhered to each of the side surfaces and the base surface and be configured to adhere to the flat panel on a portion of the major surfaces and an edge surface. Alternatively, a single sided adhesive tape can be adhered to the base surface and can be configured to cushion an edge surface of the flat panel. In another particular example, single sided adhesive tapes can be adhered to each of the side surfaces and base surface and configured to hold the flat panel in place by an interference fit and to cushion an edge surface of the flat panel.

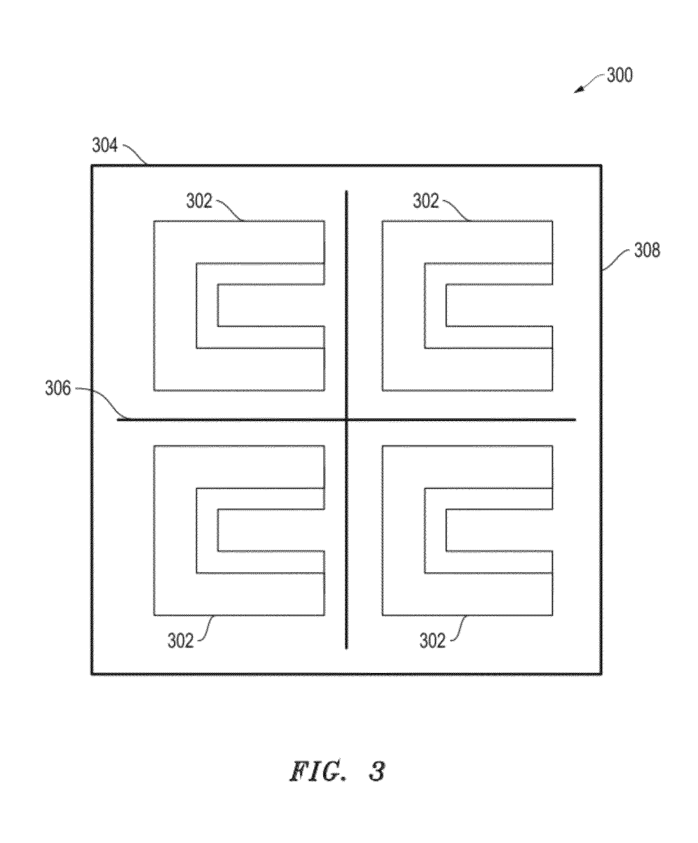

FIG. 3 illustrates an exemplary shipping assembly 300 for transporting a plurality of frame assemblies 302, such as frame assemblies 100 and 200. The shipping assembly 300 can include a packaging 304 and a plurality of frame assemblies 302. The packaging 304 can be sufficient to protect the frame assemblies 302 during transport using, for example, commercial freight services via land, air, or sea. The packaging 304 can serve to fix the position of each frame assembly 302 with respect to the other frame assemblies 302. The frame assemblies are generally shipped without flat panels in assembled form.

The packaging 304 can include a separator 306 and an exterior binding 308. The separator 306 can separate the frame assemblies 302 from one another and can substantially prevent damage, such as dents and scratches, to the frame assemblies 302 caused by contact with one another during transport. In an embodiment, the separator 306 can include a framework extending along the length of the frame assemblies 302, a plurality of spacers placed between adjacent frame assemblies 302 at points along the length of the frame assemblies 302, or any combination thereof. In additional embodiments, the separator 306 can include a polymer film, an expandable foam, a packaging peanut, a paper product, an air-filled polymer bag, another suitable material, or any combination thereof.

The exterior binding 308 can hold the frame assemblies 302 and the separator 306 together, such as in compression. Additionally, the exterior binding 308 may substantially prevent damage to the frame assemblies 302 caused by contact with external objects. In an embodiment, the exterior binding can include straps placed around the frame assemblies 302 and the separator 306 at points along the length of the frame assemblies 302, a polymer film wrapping the frame assemblies and the separator, or a box placed around the frame assemblies and the separator. In an embodiment, the exterior binding can include straps, a polymer film, a box, other suitable materials, or any combination thereof.

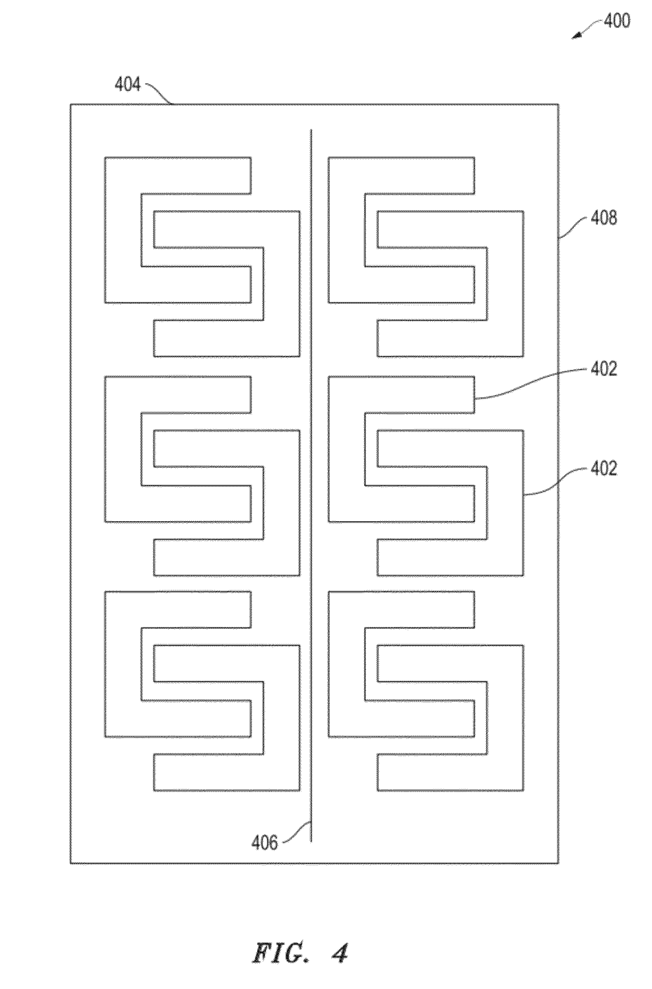

FIG. 4 illustrates another exemplary shipping assembly 400 for transporting a plurality of frame assemblies 402, such as frame assemblies 100 and 200. The shipping assembly 400 can include a packaging 404 and a plurality of frame assemblies 402. The packaging 404 can be sufficient to protect the frame assemblies 402 during transport using, for example, commercial freight services via land, air, or sea. The packaging 404 can serve to fix the position of each frame assembly 402 with respect to the other frame assemblies 402. The packaging 404 can include a separator 406 and an exterior binding 408. The frame assemblies are generally shipped without flat panels in assembled form.

The frame assemblies can be arranged so that two frame assemblies are joined in an interlocking unit, with a portion of one frame assembly inserted into the groove of the adjacent frame assembly. The interlocking units can be arranged adjacent one another, such as in direct contact with one another, or with a separator 406 in between.

In a particular embodiment, the separator 406 can be a polymer film, paper sheet, or any combination thereof that is placed between or around adjacent frame assemblies. Additionally, the exterior binding can include cardboard packaging placed around the frame assemblies 402 and held in place by metal straps.

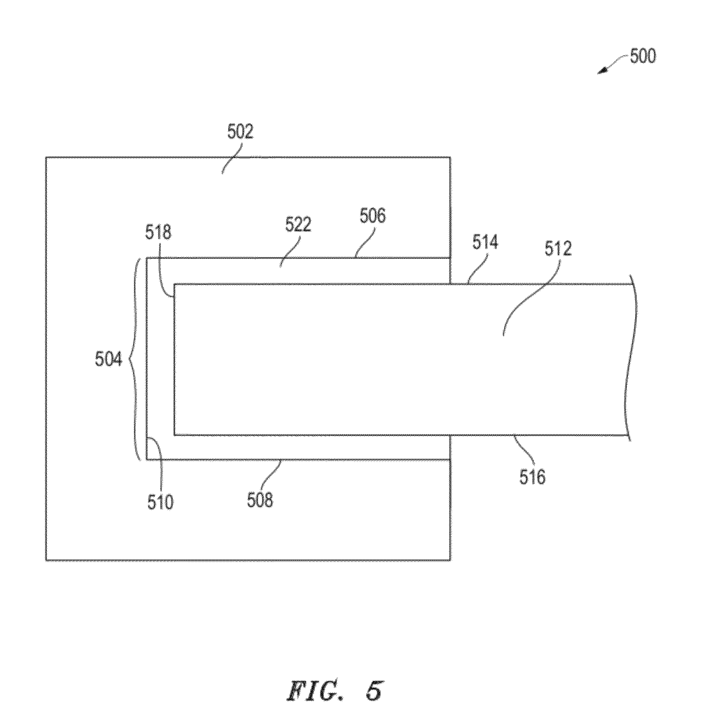

FIG. 5 illustrates an exemplary embodiment of a panel assembly 500. The panel assembly 500 can include a frame 502 having a groove 504. The groove 504 can include side surfaces 506 and 508 and a base surface 510. The panel assembly can further include a flat panel 512 having major surfaces 514 and 516 and a peripheral edge 518. The flat panel 512 may be formed of rigid substrates or flexible substrates. The flat panel 512 can be of any reasonable shape. For instance, the flat panel 512 may be square, rectangular, etc.

Any exemplary flat panel may be used. For example, the panel assembly 500 may be a photovoltaic device wherein the flat panel 512 includes a crystalline silicon polymeric substrate. The photovoltaic device to be framed may include exterior surfaces of glass, metal foil, or polymeric films such as fluoropolymers, polyolefins, or polyesters and the like. Alternatively, the flat panel 512 can be an active panel, such as a display panel, or a passive panel, such as a dry erase board or black board.

In an embodiment, it is possible to adapt the actual shape of the flat panel 512, in order to improve the effectiveness of the adhesive or to make it easier to fit into the groove 504. Thus, it is possible to use a flat panel whose peripheral edge 518 is beveled, thereby making it possible to define a wider peripheral edge 518, which no longer has a simple rectangular cross section but which has an at least partly trapezoidal cross section, for example. The beveled peripheral edge can provide a greater surface area to come in contact with the adhesive.

An adhesive 522 is disposed within the groove 504. Further, the flat panel 512 is disposed within the adhesive 522 such that the groove 504 of the frame 502 houses the flat panel 512 and the adhesive 522. The adhesive 522 can contact the surfaces 506, 508 and 510 of the groove and the peripheral edge 518 of the flat panel 512.

In an embodiment, the adhesive can have a compression ratio of at least about 20% to ensure a tight seal between the frame 502 and the flat panel 512. In embodiments, the adhesive can have a compression of at least about 20%, such as at least about 30%, even at least about 40%. Generally, the compression ratio is not greater than about 65%. Significantly, when the compression ratio is higher than about 65%, the force required to compress the adhesive tape can be high enough to peel the adhesive tape away from the surface of the frame. As used herein, the compression ratio is the difference between the thickness of the adhesive before (T_{B}) and after (T_{A}) insertion of the flat panel divided by the thickness of the adhesive before insertion of the flat panel, (T_{B}−T_{A}/T_{B}).

The panel assembly 500 can include, for example, any device or assembly where water vapor impermeability and significant mechanical strength is desired. Exemplary panel assemblies 500 include, for example, electronic devices, photovoltaic devices, insulating glass assemblies, and the like. For instance, photoactive devices, such as electronic devices, may be formed on the flat panel 512 using techniques such as semiconductor processing techniques and printing techniques. These photoactive devices may be connected using conductive interconnects, such as metallic interconnects and/or semiconductor interconnects. Metallic interconnects, for example, include gold, silver, titanium, or copper interconnects. Further, any other material, substrate, or the like, used to construct a framed device, such as a photovoltaic device may be envisioned.

In an exemplary embodiment, the adhesive 522 can be substantially impermeable to water vapor. For instance, the adhesive 522 can have a water vapor permeability of not greater than about 100 g/m²·24 h. In an embodiment, the adhesive 522 can be an adhesive tape having a water vapor permeability of not greater than about 80 g/m²·24 h, such as not greater than about 60 g/m²·24 h. In a particular embodiment, the adhesive tape can have a water vapor permeability of not greater than about 20 g/m²·24 h, such as not greater than about 10 g/m²·24 h, even not greater than about 7 g/m²·24 h. In another embodiment, the adhesive 522 can be liquid or semi-liquid adhesive that in a cured state can have a water vapor permeability of not greater than about 5 g/m²/24 h, such as not greater than about 4 g/m²/24 h, or not greater than about 3 g/m²/24 h. In an exemplary embodiment, the liquid or semi-liquid adhesive can have a water vapor permeability in a cured state of not greater than or equal to about 0.5 g/m²/24 h, or even not greater than or equal to about 0.25 g/m²/24 h, according to the ASTM E 9663 T standard; meaning that they are particularly impermeable to water.

Further, the adhesive 522 has substantial adhesion to the flat panel 512 and the frame 502. The adhesive 522 preferably exhibits less than 50% adhesion failure, less than 20% adhesion failure, or even is free of adhesion failure. In a particular embodiment, the adhesive 522 exhibits substantial adhesion without the need for pre-treating the surface of a material that the foamed polymer contacts. It is important that the polymer be chosen such that it is intrinsically impermeable but also adheres very well to the materials with which it is in contact, so as to prevent the creation of diffusion paths at the interface between the seal and the material to be sealed, so as to avoid any delamination of the seal. In an embodiment, the adhesive 522 meets or exceeds expectations regarding adhesion required for photovoltaic frame applications. In a particular embodiment, the adhesive 522 is substantially self-adhesive to the flat panel 512 and the frame 502.

Further, the adhesive 522 has sufficient flexibility to allow for expansion/contraction due to thermal cycling and any difference of coefficient of temperature expansion between two different materials, for example, the flat panel 512 and the frame 502.

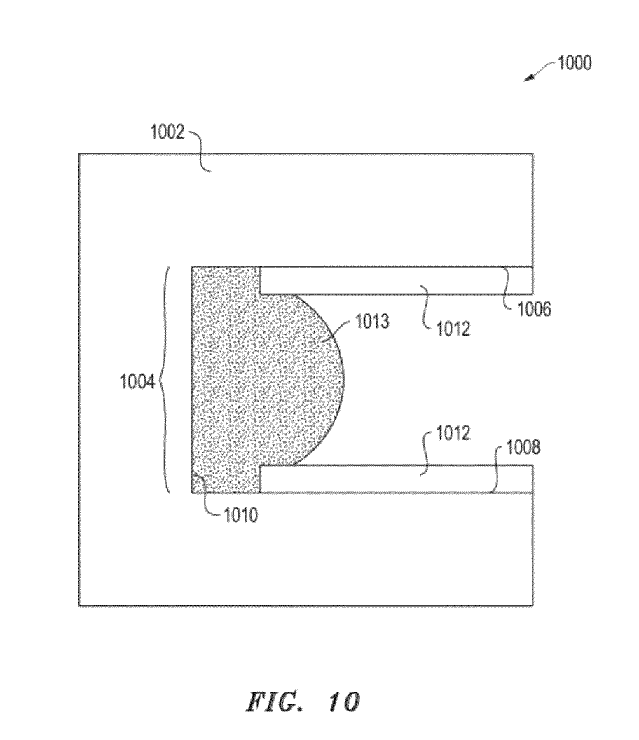

Referring now to FIG. 10, still other embodiments include an exemplary frame assembly 1000 having a frame 1002 and a groove 1004. The groove 1004 may be a channel having side surfaces 1006, 1008 and a base surface 1010. The groove 1004 may be at least partially filled with a cushion 1013. For example, cushion 1013 may comprise a non-adhesive cushioning foam, located at the bottom of the groove 1004 adjoining base surface 1010. This version is well suited for use in combination with an adhesive tape 1012 or liquid adhesive on the side surfaces 1006, 1008 of the frame 1002. Cushion 1013 may extend into contact with or beyond tape 1012 as shown.

Foams that may be used may include, for example, a pre-extruded foam such as polyvinylchloride (PVC), polyethylene (PE), polyurethane (PU), etc. Alternatively, a substance may be foamed in-place, such as a 1K PU (e.g., DYNAFOAM®). These designs provide a cushion at the bottom of the panel so that the panel does not hit the frame during framing. This design reduces shock that could provoke glass failure in the panel. Moreover, if some open space is left between the panel laminate and the bottom of the groove, moisture may accumulate in these areas. This could promote layer delamination in the laminate and provoke severe stresses when it freezes. These embodiments may include the features and elements described elsewhere herein for the other embodiments.

Turning to the method of making frame assembly, a frame can be supplied. For example, a polymer or metal can be heated to soften and extruded through a die. In another example, a sheet of material, such as a metal, can be cut and folded to form the frame. In yet another example, the groove can be machined into a block of material to form the frame, such as a polymer or metal. An adhesive can be applied within the groove to form a frame assembly.

In an embodiment, a liquid or semi-liquid adhesive can be applied within the groove. For example, a measured amount of adhesive can be applied along the length of the groove. The adhesive can be a reactive adhesive, such as moisture cured adhesive, a thermal cured adhesive, or the like, or a non-reactive adhesive, such as a thermoplastic adhesive, a contact adhesive, or the like. After application, the adhesive can become viscous to ensure the adhesive remains evenly distributed along the length of the groove. For example, the adhesive can have a viscosity of at least about 25 Pa·s at a temperature of 40° C.

In an embodiment, the adhesive can be a semi-liquid adhesive that becomes substantially solid at ambient temperatures. Heating the semi-liquid adhesive to a temperature of at least about 100° C., such as at least about 150° C., can restore the semi-liquid adhesive to a liquid form having a viscosity of not greater than about 200 Pa·s during assembly of panel assembly. In an embodiment, the polymer can be heated to a temperature as not to degrade the polymer. For instance, the polymer is heated to a temperature not greater than about 250° C., such as not greater than about 200° C.

In another embodiment, the adhesive can be applied as an adhesive tape. The adhesive tape can be a single-sided adhesive tape, a double-sided adhesive tape, or any combination thereof. The adhesive tape can be applied to the side surfaces of the groove. Additionally, the adhesive tape can be applied to the base surface of the groove. In a particular embodiment, a single adhesive tape can be folded and applied to the side surfaces and the base surface. In another embodiment, individual tapes can be applied to each of the side surfaces and the base surface.

After applying the adhesive, an optional liner can be applied to cover the groove or the adhesive. In an embodiment, the liner can substantially prevent dust, water vapor, or other materials from contacting the adhesive. When a double sided adhesive tape is used, a liner can be affixed to one of the adhesive surfaces of the adhesive tape prior to applying the adhesive tape to the surface of the groove. The liner can remain in place during assembly and shipping of the frame assembly and may be removed during assembly of the panel assembly.

To prepare for shipping, a plurality of frame assemblies can be secured within a shipping package. The shipping package can be suitable for transport, such as with a commercial carrier using land, sea, or air transport. The shipping package can substantially fix the position of each frame assembly with respect to the other frame assemblies. For example, the frame assemblies can be arranged with a separator to substantially prevent contact between the individual frame assemblies. The frame assemblies and the separator can be bound with an exterior binding. The exterior binding can compressibly hold the frame assemblies in a substantially fixed position relative to the separator. Additionally, the exterior binding may provide protection to substantially prevent the frame assemblies from being damaged by contact with other objects during transport. The shipping assembly can be shipped to a panel assembler at another location.

Upon receiving the shipping assembly, a frame assembly can be removed from the assembly and a panel can be inserted into the groove of the frame assembly to form a panel assembly. If present, a liner can be removed from the frame assembly before inserting the panel into the groove. Additional frame assemblies can be removed from the shipping assembly and additional flat panels can be inserted into the additional frame assemblies to form additional panel assemblies.

In an embodiment, the adhesive can be a semi-liquid adhesive and the frame assembly can be heated to soften the semi-liquid adhesive prior to inserting the panel. Upon heating, the viscosity of the adhesive can be reduced to not greater than about 200 Pa·s. The panel can be held in place in the groove until the frame assembly cools or cures sufficiently to hold the panel firmly in place.

In another embodiment, a liquid adhesive can be activated upon by removing the liner. Removing the liner can expose the adhesive to water vapor or other gases, such as oxygen, and activate the adhesive. The panel can be inserted into the groove and the activated adhesive can cure to firmly hold the panel in place.

In yet another embodiment, an adhesive tape can be compressed during insertion of the panel into the frame assembly. After insertion, the adhesive can have a compression ratio of at least about 30%, such as at least about 40%, even at least about 50%. The compression ratio may be not greater than about 65%. Significantly, for high compression ratios, such as greater than about 65%, the force necessary for insertion of the panel can cause the adhesive tape to peel away from the frame.

In an embodiment where the adhesive includes adhesive tapes affixed to the surfaces of the groove, inserting the panel can include inserting the panel between the adhesive tapes. Additionally, the panel can be inserted so that the edge surface of the panel contacts an adhesive tape affixed to the base surface of the groove.

### EXAMPLES

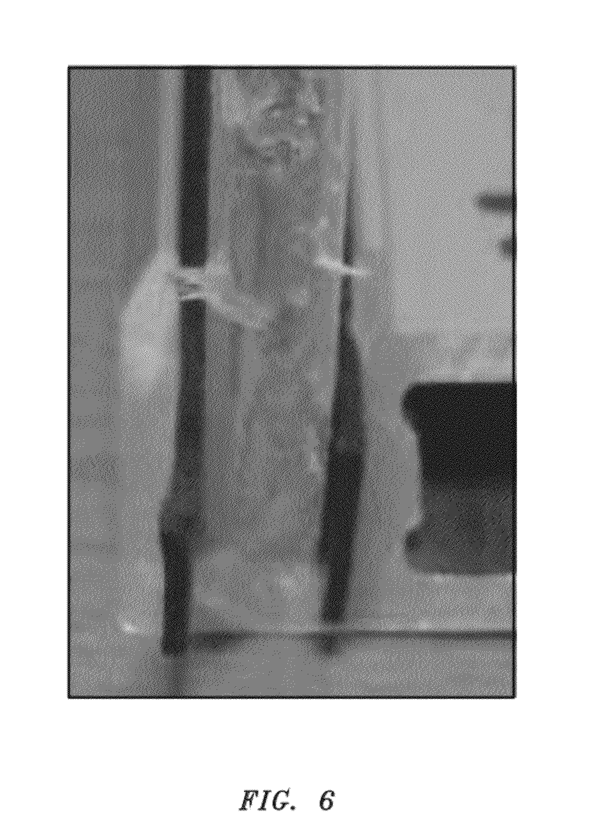

Sample 1 is prepared by applying a 0.8 mm thick double-sided polyethylene foam bonding tape (NORFIX® V7700, commercially available from Saint-Gobain Performance Plastics) to each of the two side surfaces of the groove. Upon insertion of the panel, the tape is compressed to a compression ratio of 40%. FIG. 6 shows the panel inserted into the frame.

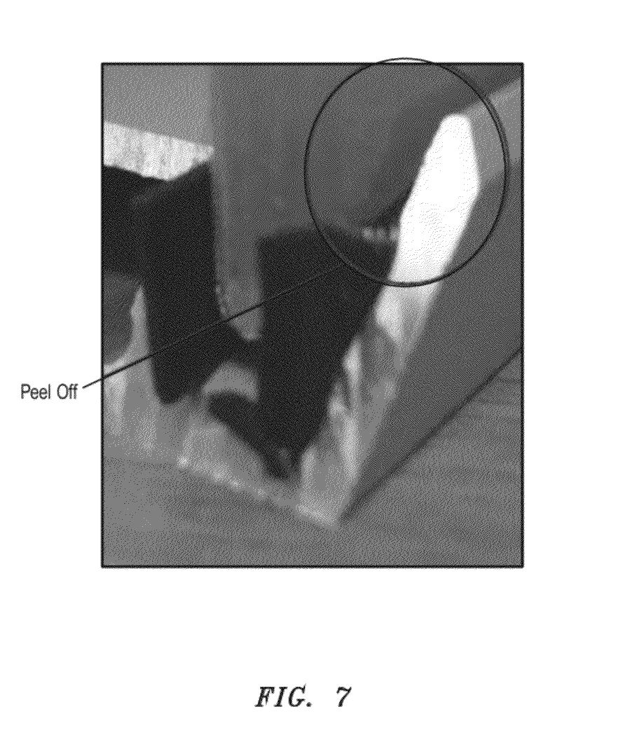

Sample 2 is prepared by applying a 0.8 mm thick double-sided polyethylene foam bonding tape and a 1.0 mm thick double-sided polyethylene foam bonding tape (NORFIX® V7700, commercially available from Saint-Gobain Performance Plastics) to first and second side surfaces of the groove respectively. Upon insertion of the panel, the tape is compressed to a compression ratio of 53%. FIG. 7 shows the panel inserted into the frame and an upper portion of the tape is peeled off a surface of the groove.

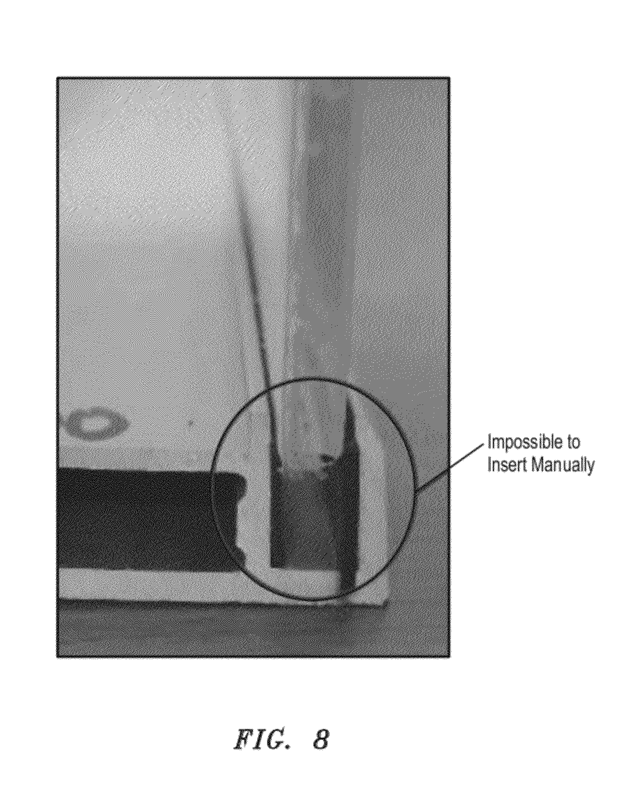

Sample 3 is prepared by applying a 0.8 mm thick double-sided polyurethane foam bonding tape and a 1.2 mm thick double-sided polyurethane foam bonding tape (NORMOUNT® V8800, commercially available from Saint-Gobain Performance Plastics) to the first and second side surfaces of the groove respectively. Insertion of a panel requires a compression ratio of 65%. FIG. 8 shows the panel cannot be manually inserted into the groove.

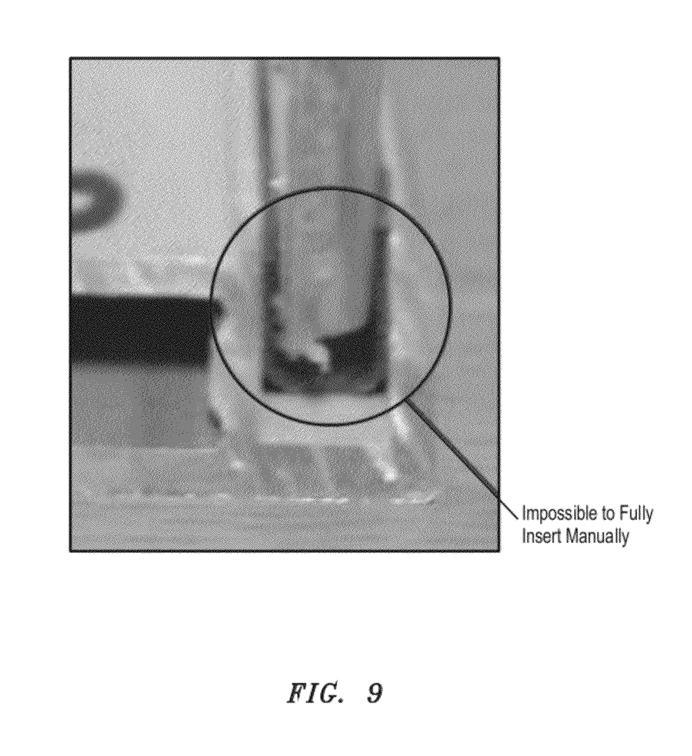

Sample 4 is prepared by applying a 0.8 mm thick double-sided polyurethane foam bonding tape (NORMOUNT® V8800, commercially available from Saint-Gobain Performance Plastics). The tape is shaped into a U-shape and inserting into the groove to contact all three surfaces of the groove. Upon insertion of the panel, the tape is compressed to a compression ratio of 40%. FIG. 9 shows a panel inserted into the groove. The panel is unable to be fully inserted to contact the lower portion of the adhesive tape using manual force.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A frame assembly for receiving a flat panel having a thickness (Tₚ), comprising:
a frame including a groove, the groove having first and second side surfaces and a base surface therebetween, the groove configured to receive an edge of the flat panel; and
an adhesive disposed within the groove, the adhesive selected from the group consisting of (i) an adhesive tape including a first adhesive surface and a compressible core, (ii) a liquid adhesive having a viscosity of at least about 25 Pa·s at a temperature of 40° C., and (iii) a semi-liquid adhesive having a viscosity of not greater than about 200 Pa·s at a temperature of 150° C., the adhesive in contact with one of the first side surface, the second side surface, the base surface, and any combination thereof, wherein the frame is free of a flat panel such that the adhesive is in contact with the frame but not a flat panel.

2. The frame assembly of claim 1, wherein the groove and the adhesive tape define an open gap for receiving the flat panel, the open gap having a width (W_{g}) not greater than T_{P}.

3. The frame assembly of claim 2, wherein W_{g} is not greater than 95% T_{P}, not greater than 90% T_{P},not greater than 85% T_{P}, or not greater than 80% T_{P}.

4. The frame assembly of claim 1, wherein the adhesive tape has a second adhesive surface configured to adhere to the panel, and further comprising a liner covering the second adhesive surface of the adhesive tape, and the liner is configured to substantially prevent dust from contacting the second adhesive surface of the adhesive tape.

5. The frame assembly of claim 1, wherein the panel is selected from the group consisting of a photovoltaic panel, a back panel for a photovoltaic assembly, an active panel, a display panel, a passive panel, a dry erase board, and a black board.

6. The frame assembly of claim 1, wherein the adhesive tape is affixed to each of the first side surface, the second side surface, and the base surface.

7. The frame assembly of claim 1, wherein the groove has a depth of 2 mm to 25 mm, or 5 mm to 20 mm; and the groove has a width of 2 mm to 20 mm, or 4 mm to 15 mm.

8. A frame assembly for receiving a flat panel having a thickness (Tₚ), comprising:
a frame including a groove, the groove having first and second side surfaces and a base surface therebetween, the groove configured to receive an edge of the flat panel;
an adhesive disposed only on the first and second side surfaces within the groove but not the base surface, the adhesive selected from the group consisting of (i) an adhesive tape, (ii) a liquid adhesive, and (iii) a semi-liquid adhesive, the adhesive being in contact with the first and second side surfaces but not the base surface; and
a cushion on the base surface, the cushion being formed from a material that differs from the adhesive.

9. The frame assembly of claim 8, wherein the cushion extends into contact with the adhesive.

10. The frame assembly of claim 8, wherein the cushion is a pre-extruded, non-adhesive cushioning foam, and the cushion is selected from the group consisting of polyvinylchloride, polyethylene, polyurethane, and any combination thereof.

11. A method of assembling a panel, comprising:
receiving a shipping package suitable for transport, the shipping package including a plurality of frame assemblies, each frame assembly comprising:
a frame including a groove configured to receive a panel, the groove having first and second side surfaces and a base surface therebetween; and
an adhesive disposed within the groove, the adhesive selected from the group consisting of (i) an adhesive tape including a first adhesive surface and a compressible core, (ii) a liquid adhesive having a viscosity of at least about 25 Pa·s at a temperature of 40° C., and (iii) a semi-liquid adhesive having a viscosity of not greater than about 200 Pa·s at a temperature of 150° C.;
removing a first frame assembly from the shipping package; and
inserting a panel into the groove of the first frame assembly.

12. The method of claim 11, further comprising removing a second frame assembly from the shipping package, and inserting a second panel into the groove of the second frame assembly.

13. The method of claim 11, wherein the shipping package is configured to fix the position of each frame assembly with respect to the other frame assemblies.

14. The method of claim 13, wherein the packaging includes a separator and an exterior binding, the exterior binding is configured to hold the frame assemblies in compression, and the exterior binding includes straps, polymer film, box, or any combination thereof.

15. The method of claim 14, wherein the separator includes a framework, a plurality of spacers, an expandable foam, a packaging peanut, a paper product, a polymer film, an air filled polymer bag, or any combination thereof.

16. The method of claim 11, wherein, after inserting the panel into the groove, the adhesive tape has a compression ratio at least about 20%, at least about 30%, at least about 40%, or not greater than about 65%.

17. The method of claim 11, further comprising removing a liner to expose the adhesive within the groove, the liner is configured to substantially prevent dust from contacting the adhesive, and the liner is configured to substantially prevent water vapor from contacting the adhesive.

18. The method of claim 11, further comprising heating the adhesive to a temperature from 100° C. to 250° C. to reduce the viscosity of the adhesive to not greater than about 200 Pa·s.

19. A method of preparing a frame assembly for shipping, comprising:
providing a plurality of frames, each frame including a groove configured to receive a flat panel, the groove having first and second side surfaces and a base surface therebetween;
applying an adhesive within the groove of each frame to form a plurality of frame assemblies, the adhesive selected from the group consisting of (i) an adhesive tape including a first adhesive surface and a compressible core, (ii) a liquid adhesive having a viscosity of at least about 25 Pa·s at a temperature of 40° C., and (iii) a semi-liquid adhesive having a viscosity of not greater than about 200 Pa·s at a temperature of 150° C.; and
securing the frame assemblies within a shipping package suitable for transport.

20. The method of claim 19, further comprising shipping the shipping package to a panel assembler.
